(19) United States
(12) Patent Application Publication
(10) Pub. No.: US 2026/0124544 A1
(43) Pub. Date: May 7, 2026

(54) SYNCHRONIZATION OF AUDIO WITH TEMPO OF IN-GAME RELATED ACTIONS FOR A VIDEO CLIP OF A GAME PLAY OF VIDEO GAME

(71) Applicant: Sony Interactive Entertainment Inc., Tokyo (JP)

(72) Inventor: Michael Harrison Prosinski, Burlingame, CA (US)

(21) Appl. No.: 18/934,746

(22) Filed: Nov. 1, 2024

(51) Int. Cl. A63F 13/67; A63F 13/54; G06V 20/40; G11B 27/19

(52) U.S. Cl. CPC A63F 13/67; A63F 13/54; G06V 20/41; G11B 27/19

(57) ABSTRACT

A method including capturing information related to a game play of a video game presented in a video clip. The method includes executing an artificial intelligence (AI) model using the information to determine a game play tempo of in-game related actions for the game play of the video game. The method including executing the AI model to synchronize an audio track to the game play tempo. The method including overlaying the audio track that is synchronized to the video clip for presentation.

### TECHNICAL FIELD

The present disclosure is related to synchronizing an audio track with a game play tempo corresponding with a video clip of a game play of a video game. In particular, artificial intelligence is used to identify in-game related actions corresponding with the game play in the video clip, and determine the game play tempo based on the in-game related actions. Further, artificial intelligence is used to manipulate the audio track to be in alignment with the game play tempo. In that manner, the video clip may be overlaid with a new audio track that provides a theatrical and/or impactful user experience.

### BACKGROUND OF THE DISCLOSURE

Video games and/or gaming applications and their related industries (e.g., video gaming) are extremely popular and represent a large percentage of the worldwide entertainment market. Video games are played anywhere and at any time using various types of platforms, including gaming consoles, desktop computers, laptop computers, mobile phones, tablet computers, etc.

When a video game is played, a base soundtrack accompanies the game play. The base soundtrack is typically created by the developer of the video game. This base soundtrack plays in the background, and is preselected for each of the scenes in the video game. For example, a scene may include walking along a path to reach a desired location in a virtual environment. The player may not necessarily be stressed in this scenario. As such, the corresponding soundtrack may produce peaceful sounds of lower volume that are indicative of a low stress part of the video game. On the other hand, another scene may include the final operations to complete a task that may be stressful for the player. In this case, the corresponding soundtrack may produce sounds that are loud and climactic, and indicative of a high stress part of the game.

However, the base sound track may not satisfy the player playing the video game. That is, the user may find the base soundtrack unstimulating, and thus may be bored with the base soundtrack accompanying the game play of the video game. Many players may even turn down the volume of the base soundtrack, and instead play their own music on their sound systems. For example, some players may play classical music or hard rock in the background. Even though the player prefers this music over the base soundtrack, there are limitations, as the player selected music may not necessarily correspond with the actions in the game play of the video game

It is in this context that embodiments of the disclosure arise.

### SUMMARY

Embodiments of the present disclosure relate to synchronizing an audio track with a game play tempo corresponding with a video clip of a game play of a video game. Artificial intelligence is used to determine a game play tempo for a video clip of a game play of a video game based on identified in-game related actions (e.g., user based, character based, etc.). An audio track accompanying the video clip is synchronized with the game play tempo. The audio track may be the base soundtrack, user selected audio, or audio generated for the video clip using artificial intelligence. The video clip may be a recorded clip of a previous game play, which may stand-alone or may be incorporated into a highlight reel, wherein the audio track is manipulated during post processing after the game play. The video clip may also be generated for a live game play, wherein the audio track is dynamically manipulated during the game play. In that manner, an audio track for a video clip is newly generated and provides provide a more impactful experience for the viewer, wherein the audio track is manipulated to be in synchronization with the game play tempo of the video clip. For example, because the audio track is in synchronization with in-game related actions, such as those used for determining the game play tempo, the audio track innately supports and corresponds with the video clip to provide the viewer a more intimate experience.

In one embodiment, a method is disclosed. The method including capturing information related to a game play of a video game presented in a video clip. The method including executing an artificial intelligence (AI) model using the information to determine a game play tempo of in-game related actions for the game play of the video game. The method including executing the AI model to synchronize an audio track to the game play tempo. The method including overlaying the audio track that is synchronized to the video clip for presentation.

In another embodiment, a non-transitory computer-readable medium storing a computer program for performing a method is disclosed. The non-transitory computer-readable medium including program instructions for capturing information related to a game play of a video game presented in a video clip. The non-transitory computer-readable medium including program instructions for executing an artificial intelligence (AI) model using the information to determine a game play tempo of in-game related actions for the game play of the video game. The non-transitory computer-readable medium including program instructions for executing the AI model to synchronize an audio track to the game play tempo. The non-transitory computer-readable medium including program instructions for overlaying the audio track that is synchronized to the video clip for presentation.

In still another embodiment, a computer system is disclosed, wherein the computer system includes a processor and memory coupled to the processor and having stored therein instructions that, if executed by the computer system, cause the computer system to execute a method. The method including capturing information related to a game play of a video game presented in a video clip. The method including executing an artificial intelligence (AI) model using the information to determine a game play tempo of in-game related actions for the game play of the video game. The method including executing the AI model to synchronize an audio track to the game play tempo. The method including overlaying the audio track that is synchronized to the video clip for presentation.

Other aspects of the disclosure will become apparent from the following detailed description, taken in conjunction with the accompanying drawings, illustrating by way of example the principles of the disclosure.

### BRIEF DESCRIPTION OF THE DRAWINGS

The disclosure may best be understood by reference to the following description taken in conjunction with the accompanying drawings in which:

FIG. 1 illustrates a system configured for synchronizing an audio track with a game play tempo of a video clip showing game play of a video game, in accordance with one embodiment of the present disclosure.

FIG. 2 is a flow diagram illustrating a method for synchronizing an audio track with a game play tempo of a video clip showing game play of a video game, in accordance with one embodiment of the present disclosure.

FIG. 3 is an illustration of a system configured to implement an AI model configured for extracting and classifying relevant information related to a video clip showing a game play of a video game, and to synchronize an audio track with a game play tempo of the game play in the video clip, in accordance with one embodiment of the present disclosure.

FIG. 4 is a diagram illustrating the synchronization of an audio track with a game play tempo of a game play of a video game shown in a video clip, in accordance with one embodiment of the present disclosure.

FIG. 5 illustrates components of an example device that can be used to perform aspects of the various embodiments of the present disclosure.

### DETAILED DESCRIPTION

Although the following detailed description contains many specific details for the purposes of illustration, anyone of ordinary skill in the art will appreciate that many variations and alterations to the following details are within the scope of the present disclosure. Accordingly, the aspects of the present disclosure are set forth without any loss of generality to, and without imposing limitations upon, the claims that follow this description.

Generally speaking, the various embodiments of the present disclosure describe systems and methods for synchronizing an audio track with a game play tempo corresponding with a video clip of a game play of a video game that is live or recorded, using artificial intelligence. In particular, artificial intelligence can be used to identify in-game related actions corresponding with the game play in the video clip, and determine the game play tempo based on the in-game related actions. Artificial intelligence is used to manipulate the audio track to be in synchronization and/or alignment with the game play tempo. For example, the audio track can be stretched or shrunken in time (e.g., increasing or decreasing a beats per period of time) to occur with in-game related actions and/or events in the game play, and further without compromising the pitch (e.g., frequency) in the music, in embodiments. The video clip may be overlaid with the modified audio track for viewing. In that manner, the video clip is overlaid with the new and/or modified audio track, in order to give the user a more personal, and/or theatrical or impactful experience when viewing the video clip.

Advantages of the methods and systems, configured to synchronizing an audio track with a game play tempo corresponding with a video clip of a game play of a video game, include the generation of a customized audio track to accompany a video clip, wherein the audio track may be newly generated, selected for play with the video clip, and/or captured from the original game play in the video clip. In particular, the customized audio track is synchronized with the game play tempo corresponding with in-game related actions of the game play in the video clip. As such, the video clip that is overlaid with the synchronized audio track provides for a more personal, and/or theatrical or impactful experience when viewing.

Throughout the specification, the reference to “game” or “video game” or “gaming application” is meant to represent any type of interactive application that is directed through execution of input commands. For illustration purposes only, an interactive application includes applications for gaming, word processing, video processing, video game processing, etc. Also, the terms “virtual world” or “virtual environment” or “metaverse” is meant to represent any type of environment generated by a corresponding application or applications for interaction between a plurality of users in a multi-player session or multi-player gaming session. Furthermore, the term “platform” refers to a combination of hardware and software components providing a set of capabilities in order to execute one or more software applications (e.g., video games). For example, the term “platform” may be used with reference to “devices of a particular platform” or “cross-platform devices.” Moreover, suitable terms introduced above are interchangeable.

Throughout the specification, synchronization of an audio track is described in relation to a video clip of a game play of a video game for clarity and brevity. However, it is understood that synchronization of an audio track may be applied to one or more video clips of one or more game plays of one or more video games, wherein the audio track may include one or more audio segments, each corresponding with the a corresponding video clip.

With the above general understanding of the various embodiments, example details of the embodiments will now be described with reference to the various drawings.

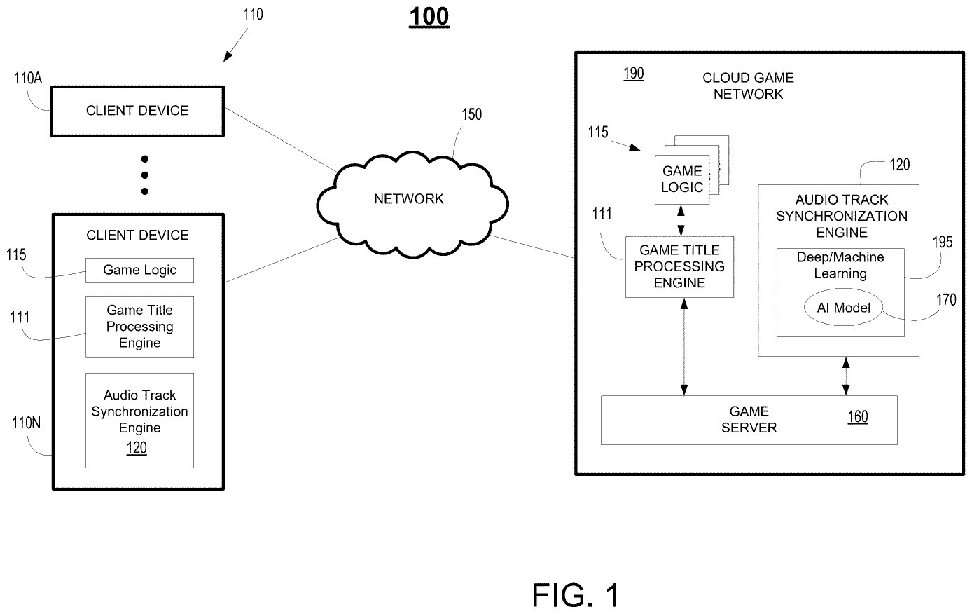

FIG. 1 illustrates a system 100 configured for synchronizing, using artificial intelligence, an audio track with a game play tempo corresponding with a video clip of a game play of a video game, in accordance with one embodiment of the present disclosure. As previously introduced, system 100 is configurable to handle one or more video clips of one or more game plays of one or more video games when synchronizing the audio track that may include one or more audio segments, each corresponding with the a corresponding video clip. In that manner, a customized audio track is generated that is synchronized with the game play tempo of the video clip.

As shown, system 100 may provide gaming over a network 150 for one or more client devices 110 (e.g., 110A through 110N) of one or more users. In particular, system 100 may be configured to enable users to interact with interaction applications, including providing gaming to users participating in a single-player or multi-player gaming sessions (e.g., participating in a video game in single-player or multi-player mode, or participating in a metaverse generated by an application with other users, etc.) via a cloud game network 190, wherein the game can be executed locally (e.g., on a local client device 110 of a corresponding user) or can be executed remotely from a corresponding client device 110 (e.g., acting as a thin client) of the corresponding user that is playing the video game, in accordance with one embodiment of the present disclosure. In at least one capacity, the cloud game network 190 supports a multi-player gaming session for a group of users, to include delivering and receiving game data of players for purposes of coordinating and/or aligning objects and actions of players within a scene of a gaming world or metaverse, managing communications between user, etc., so that the users in distributed locations participating in a multi-player gaming session can interact with each other in the gaming world or metaverse in real-time. In another capacity, the cloud game network 190 supports multiple users participating in a metaverse.

In some embodiments, the cloud game network 190 may include a plurality of virtual machines (VMs) running on a hypervisor of a host machine, with one or more virtual machines configured to execute a game processor module utilizing the hardware resources available to the hypervisor of the host. It should be noted, that access services, such as providing access to games of the current embodiments, delivered over a wide geographical area often use cloud computing. Cloud computing is a style of computing in which dynamically scalable and often virtualized resources are provided as a service over the internet.

In a multi-player session allowing participation for a group of users to interact within a gaming world or metaverse generated by an application (which may be a video game), some users may be executing an instance of the application locally on a client device (e.g., gaming console, tablet, mobile phone, etc.) to participate in the multi-player session. Other users who do not have the application installed on a selected device or when the selected device is not computationally powerful enough to executing the application may be participating in the multi-player session via a cloud based instance of the application executing at the cloud game network 190.

As shown, the cloud game network 190 includes a game server 160 that provides access to a plurality of video games. Applications played in a corresponding single player and/or multi-player session may be played over the network 150 with connection to the game server 160. For example, in a multi-player session involving multiple instances of an application (e.g., generating virtual environment, gaming world, metaverse, etc.), a dedicated server application (session manager) collects data from users and distributes it to other users so that all instances are updated as to objects, characters, etc. to allow for real-time interaction within the virtual environment of the multi-player session, wherein the users may be executing local instances or cloud based instances of the corresponding application. In particular, game server 160 may manage a virtual machine supporting a game processor that instantiates a cloud based instance of an application for a user. As such, a plurality of game processors of game server 160 associated with a plurality of virtual machines is configured to execute multiple instances of one or more applications associated with gameplays of a plurality of users. In that manner, back-end server support provides streaming of media (e.g., video, audio, etc.) of gameplays of a plurality of applications (e.g., video games, gaming applications, etc.) to a plurality of corresponding users. That is, game server 160 is configured to stream data (e.g., rendered images and/or frames of a corresponding gameplay) back to a corresponding client device 110 through network 150. As such, a computationally complex gaming application may be executing at the back-end server in response to controller inputs received and forwarded by client device 110. Each server is able to render images and/or frames that are then encoded (e.g., compressed) and streamed to the corresponding client device for display.

In single-player or multi-player sessions, instances of an application may be executing locally on a client device 110 or at the cloud game network 190. In either case, the application as game logic 115 is executed by a game engine 111 (e.g., game title processing engine). For purposes of clarity and brevity, the implementation of game logic 115 and game engine 111 is described within the context of the cloud game network 190. In particular, the application may be executed by a distributed game title processing engine (referenced herein as “game engine”). In particular, game server 160 and/or the game title processing engine 111 includes basic processor based functions for executing the application and services associated with the application. For example, processor based functions include 2D or 3D rendering, physics, physics simulation, scripting, audio, animation, graphics processing, lighting, shading, rasterization, ray tracing, shadowing, culling, transformation, artificial intelligence, etc. In that manner, the game engines implement game logic, perform game calculations, physics, geometry transformations, rendering, lighting, shading, audio, as well as additional in-game or game-related services. In addition, services for the application include memory management, multi-thread management, quality of service (QOS), bandwidth testing, social networking, management of social friends, communication with social networks of friends, social utilities, communication channels, audio communication, texting, messaging, instant messaging, chat support, game play replay functions, help functions, etc.

In one embodiment, the cloud game network 190 may support artificial intelligence (AI) based services including chatbot services (e.g., ChatGPT, etc.) that provide for one or more features, such as conversational communications, composition of written materiel, composition of music, answering questions, simulating a chat room, playing games, and others.

Users access the remote services with client devices 110, which include at least a CPU, a display and input/output (I/O). For example, users may access cloud game network 190 via communications network 150 using corresponding client devices 110 configured for providing input control, updating a session controller (e.g., delivering and/or receiving user game state data), receiving streaming media, etc. The client device 110 can be a personal computer (PC), a mobile phone, a personal digital assistant (PAD), handheld device, etc.

The client devices 110 may be operating using different platforms. For example, one or more client devices may be operating on a first platform (e.g., gaming consoles), and other client devices may be operating a different platform (mobile phones). In still another platform, a platform includes both a client device and game server 160 located at the cloud game network 190 in support of a cloud based instance of an application. As previously described, each platform may include a combination of hardware and software components providing a set of capabilities in order to execute one or more software applications (e.g., video games).

In particular, client device 110 of a corresponding user is configured for requesting access to applications over a communications network 150, such as the internet, and for rendering for display images generated by a video game executed by the game server 160, wherein encoded images are delivered (i.e., streamed) to the client device 110 for display. For example, the user may be interacting through client device 110 with an instance of an application executing on a game processor of game server 160 using input commands to drive a gameplay. Client device 110 may receive input from various types of input devices, such as game controllers, tablet computers, keyboards, touch screens, gestures captured by video cameras, mice, touch pads, audio input, etc.

As previously introduced, client device 110 may be configured with a game title processing engine 111 and game logic 115 (e.g., executable code) that is locally stored for at least some local processing of an application, and may be further utilized for receiving streaming content as generated by the application executing at a server, or for other content provided by back-end server support. In another implementation, client decide 110 acts as a stand-alone system for purposes of executing the application, such as when supporting a game play of a video game.

In another embodiment, client device 110 may be configured as a thin client providing interfacing with a back end server (e.g., game server 160 of cloud game network 190) configured for providing computational functionality (e.g., including game title processing engine 111 executing game logic 115—i.e., executable code-implementing a corresponding application).

In addition, system 100 includes an audio track synchronization engine 120 configured to synchronize an audio track with a game play tempo corresponding with a video clip of a game play of a video game using artificial intelligence. In particular, artificial intelligence can be used to identify in-game related actions corresponding with the game play in the video clip, and determine the game play tempo based on the in-game related actions. The video clip may correspond with recorded or live game play, and in some cases, may be included within a highlight reel of one or more video clips from one or more game plays of one or more video games. For example, metadata is captured to determine tempo of the game play. An audio track may be generated or selected, or captured from the game play in the video clip. Artificial intelligence is used to manipulate the audio track to be in synchronization and/or alignment with the game play tempo. For example, the audio track can be stretched or shrunken in time (e.g., increasing or decreasing a beats per period of time) to occur with in-game related actions and/or events in the game play, and further without compromising the pitch (e.g., frequency) in the music, in embodiments. As an illustration, in an action sequence occurring within a game play the user may be providing controller inputs at a particular rate that is quick and extended (e.g., repeated actions by the user that are pretty constant), wherein the rate of controller inputs corresponds with the in-game related actions. As such, the audio track may be modified using artificial intelligence such that the beats per minute of the audio track is synchronized and/or aligned with the rate of the controller inputs entered by the user. The video clip may be overlaid with the modified audio track for viewing.

The audio track synchronization engine 120 may be implemented at the back-end cloud game network, or as a middle layer third party service that is remote from the client device. In some implementations, the audio track synchronization engine 120 may be located at a client device 110. That is, the audio track synchronization engine 120 may be local to a user, such as operating within a client device 110 of the user, or may be remote from the user and operate at a back-end server.

The audio track synchronization engine 120 is configured to classify and/or identify information related to a game play of a video game corresponding with a video clip using artificial intelligence. One or more items of information are necessary to determine game play tempo of the game play, and/or to generate an audio track to accompany the video clip, wherein the audio track is synchronized with the game play tempo and overlaid the video clip using artificial intelligence. For example, information identified using artificial intelligence, for purposes of audio track generation and/or audio track synchronization, may include in-game related actions (e.g., user based actions for controlling the game play, character and/or object based actions within the game play, actions in the game play, etc.), timing of the in-game audio or base soundtrack generated to accompany the game play shown in the video clip (the timing may be used for determining the game play tempo and/or synchronizing the audio track to the game play tempo), music style, key events in the game play (e.g., used to determine a context of game play, and then generate an audio track for that game play), and an AI generated audio track.

Artificial intelligence is used to analyze game state data of a plurality of game plays of the video game by a user, the game state data of the game play of the video game by the user, screen shots from the game plays of the user, captured base soundtrack, user selected soundtracks from a playlist, and any other data useful in determining a game play tempo of a corresponding video clip, and to synchronize a corresponding audio track to the game play tempo. The classification and/or identification of information related to a game play of a video game corresponding with a video clip, game play tempo corresponding with a video clip of a game play of a video game that is live or recorded, and the synchronization of an audio track with the game play tempo may be performed using artificial intelligence (AI) via an AI layer. For example, the AI layer may be implemented via an AI model 170 as executed by a deep/machine learning engine 195 of the recap engine 120. It is understood that one or more AI models may be implemented, each of which being configured to perform customized classification and/or identification and/or generation of data (e.g., game play tempo, in-game related actions, timing of the in-game audio or base soundtrack generated to accompany the game play shown in the video clip, music style, key events in the game play, and an AI generated audio track, etc.).

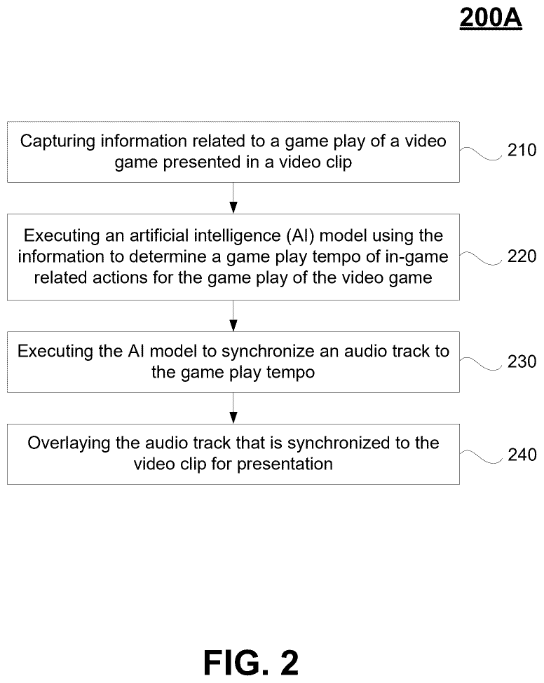

With the detailed description of the system 100 of FIG. 1, flow diagram 200 of FIG. 2 discloses a method for synchronizing an audio track with a game play tempo of a video clip showing game play of a video game, using artificial intelligence, in accordance with one embodiment of the present disclosure. In that manner, a video clip may be overlaid with a customized audio track providing a more personal, more theatrical, and/or more impactful user experience. The operations performed in the flow diagram may be implemented by one or more of the previously described components of system 100 described in FIG. 1, including the audio track synchronization engine 120.

At 210, the method includes capturing and/or accessing information related to a game play of a video game presented in a video clip. For example, game state data for the game play may be captured, such as when the game play is live and streaming to the client device. Also, game state data may be accessed, such as when the game play is recorded in the video clip. For example, a developer of the video game may allow for access to the game state on developer servers, or for the game state to be streamed (e.g., for use by the audio track synchronization engine 120. Game state data allows for the generation of the gaming environment at the corresponding point in the game play. Along with game state, user saved data may be captured and/or accessed, wherein the user saved data personalizes the video game for the corresponding player.

Other information may be collected, such as screen shots of the game play (e.g., the video frames). In particular, a plurality of image frames of the video clip is captured and/or accessed. For example, screen shot data may be utilized when it is more suitable for processing, or when game state data is unavailable, or when game state data is too cumbersome to process. The screen shot data may be analyzed to determine context of the game play, and/or identify actions, and/or in-game related actions all associated with the game play of the video game.

Still other information may be collected (e.g., captured and/or accessed). For instance, biometric information related to a user controlling the game play of the video game may be captured. The video clip may also be collected, to include capturing and/or accessing audio segments from the video clip. In addition, the base soundtrack played in the video clip may also be collected, or selected music or genres of music played in association with the video clip may also be collected. For example, a user may prefer to play a playlist of one or more songs (e.g., self-created or selected, accessed through one or more music social platforms, etc.) instead of the base soundtrack created for the video clip by the video game. Other information may still be collected that is useful for generating an audio track to accompany a video clip, and/or for synchronizing the audio track to the video clip.

At 220, the method includes executing an artificial intelligence (AI) model using the information to determine a game play tempo of in-game related actions for the game play of the video game. In particular, a plurality of features is extracted and/or classified for use by the AI model, wherein the AI model is configured to analyze the plurality of features to determine the game play tempo. For example, the AI model may analyze game state data from the game play of the video game shown in the video clip, image frames of the game play, and/or biometric data, and/or other information, for purposes of determining the game play tempo.

In embodiments, the game play tempo may be related to in-game related actions, including user based actions, or character/object based actions. For instance, artificial intelligence is used to identify in-game related actions corresponding with the game play shown in the video clip, and determine the game play tempo based on the in-game related actions. That is, the tempo is reflected of performance of the in-game related actions, and may include a rate at which the actions are performed over a certain period of time. The tempo and rate may change with changes in the rate of performing the in-game related actions. For example, user based actions may include a rate of user input configured for controlling the game play of the video game. The user input may be associated with one or more controller inputs of a controller input sequence. Further, character or object based actions include motions or sounds performed by a character or object within the game play. For example, motions include movement of parts of the character or object. As a further example, some motions are expressed by a change in facial expressions.

In addition, game play tempo may also reflect intensity of the in-game related actions. For example, magnitude and timing for each of the one or more controller inputs may be relevant to determining game play tempo, including intensity. The rate of change for the magnitude and timing may also reflect a progression of intensity over time, such as a gradual or exponential increase in intensity (e.g., a crescendo of intensity), or a gradual or exponential decrease in intensity (e.g., a decrescendo of intensity).

At 230, the method includes executing the AI model to synchronize an audio track to the game play tempo. In particular, artificial intelligence is used to manipulate the audio track to be in alignment with the game play tempo. One or more parameters of the audio track may be useful for synchronizing the audio track to the game play tempo. For instance, the audio track may be defined by a beats per period of time (e.g., beats per minute), wherein a note may be played in relation to a corresponding beat. A speed of the music may be further defined using the beats per minute, to include how many measures are played per minute, etc. For example, the beats per minute may be reflective of how fast the corresponding music is being played. In addition, articulation defines how a note or sound is played, such as that defined by a start and end time, and is sound (e.g., tone, quality, harmonics, sound envelope, etc.). Other parameters include texture, which may define the overall quality of the corresponding sound (e.g., combination of density, thickness, range of sound, sound tempo, melody, harmonics, etc.).

Synchronization of the audio track with the game play tempo involves aligning one or more of the parameters defining the audio track with the game play tempo. This may involve manipulating a beat (e.g., beats per unit time) of the audio track to synchronize with one or more the in-game related actions, such as matching beats of the audio track to occurrences of corresponding in-game related actions. Other manipulation may include varying a volume of the audio track to synchronize with occurrences of one or more the in-game related actions. Another manipulation may include manipulating the articulation of one or more notes or sounds in the audio track to be in synchronization with the one or more the in-game related actions. For example, one or more notes can each be stretched or shrunken in time to be in synchronization with occurrences of one or more the in-game related actions. In another case, the texture of one or more portions of the audio track is manipulated to synchronize with occurrences of corresponding in-game related actions.

In another embodiment, the audio track can be stretched or shrunken to synchronize with occurrences of one or more the in-game related actions. In particular, the stretching or shrinking is related to a speed of the sounds in the audio track, wherein speed can be measured in measures per minute as previously described. In some cases, the speed may be related to the number of beats per minute. As such, stretching and/or shrinking may refer to an increase or decrease in the beats per minute of the audio track to synchronize with occurrences of one or more the in-game related actions. In one embodiment, a pitch in the audio track may vary in response to stretching or shrinking of the audio track. In another embodiment, stretching and/or shrinking of the audio track to be in synchronization with the game play tempo is performed while maintaining a pitch of the audio track.

In embodiments, the audio track may be accessed from a library of tracks, such as a personal library, a web music platform, etc. For example, the audio track may be selected for playing during the live game play (e.g., in place of the base soundtrack), or for accompanying the video clip, such as when shown as a part of a highlight reel. More particularly, the audio track includes an audio segment broadcast during the video clip, wherein the audio segment is taken from a base sound track of the video game. For example, the base soundtrack is generated during execution of the video game for the game play. The audio track may include original music, such as that generated by the user playing the video game, or another music creator (e.g., friend of the user, etc.). The audio track may include a play list of one or more discrete songs selected by the user; or a play list of one or more songs of a genre selected by the user

In other embodiments, the audio track may be dynamically generated, such as using artificial intelligence. In particular, the audio track may be generated based on a game context of the game play shown in the video clip. One or more types of information may be analyzed by the AI model to determine the game context. For instance, the information may include game state data, screen shot data, key events identification (e.g., key events include important interactions with a gaming environment of the video game), and other relevant information. That is, the AI model is trained to identify a plurality of contexts of a plurality of points in any game play of the video game, and is configured to classify and/or identify a context of a game play shown in the video clip. Furthermore, the AI model is executed to determine a style of music appropriate for and/or corresponding with the game context determined based on the key events. The AI model can be executed to generate an audio track based on the determined style of music. Depending on the complexity and/or resolution of the game context determined for the video clip, the audio track may include one or more portions, each portion corresponding with a key event, wherein a corresponding portion of the audio track may be generated in alignment with the key event. For example, the audio portion may provide a backdrop to general portions of the game play (e.g., peaceful music), or an audio portion that is rising in crescendo in alignment with a battle with a boss reaching its conclusion, or an audio segment that is in staccato occurring within a battle with a boss, or any other style of music. In another example, the audio track may properly reflect the emotions of the user (e.g., intense, relaxed, agitated, etc.) generated during the game play of the video game.

At 240, the method includes overlaying the audio track that is synchronized to the video clip for presentation. That is, the audio track that is synchronized is added to (e.g., overlaid) the video clip shown in isolation and/or in combination with other video clips included in a highlight recl. In that manner, the viewer becomes more fully immersed in their own game play, as the audio track that is synchronized properly reflects the game play tempo of in the video clip. That is, the video clip is enhanced to provide an accurate auditory feel for the game play of the video game as shown in the video clip.

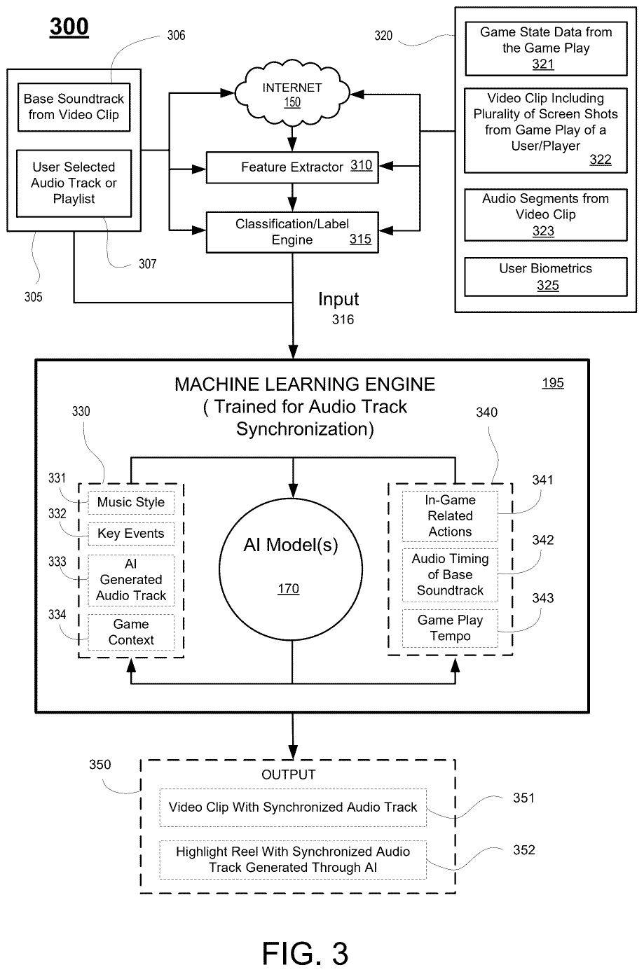

FIG. 3 is an illustration of a system 300 configured to implement an AI model configured for extracting and classifying relevant information related to a video clip showing a game play of a video game, and to synchronize an audio track with a game play tempo of the game play in the video clip, in accordance with one embodiment of the present disclosure. For purposes of illustration, the system of FIG. 3 may be implemented by the cloud game network 190 or the client device 110, or a combination thereof.

In one embodiment, the system 300 may be implemented when viewing and/or generating a video clip of a recorded game play. For example, the video clip may be included in a highlight reel that includes one or more video clips of one or more recorded game plays of one or more video games. In one instance, the highlight reel may include a review of game plays of multiple video games played by a user throughout one calendar year. In another embodiment, the system 300 may be implemented during a live game play of a video game.

In each of these implementations, FIG. 3 is an illustration of an implementation of AI model 170 that is trained, in part, to identify and/or classify in-game related actions 341 for purposes of determining a game play tempo, from which an audio track can be synchronized. Also, the AI model 170 may be configured to identify and/or classify timing 342 of audio or sounds of a base soundtrack generated for a game play of a video game. For instance, the base soundtrack that is generated by the video game, may provide some basic timing cues (e.g., when starting, engaging, and ending a boss battle), which may be used for determining a game play tempo, from which an audio track can be synchronized using artificial intelligence. Further, the AI model 170 may be configured, in part, to identify and/or classify one or more key events 332, game context 334, and music style 331. For instance, the identification of key events 332 may be used for determining a game context 334, from which a music style 331 for that game context can be determining using artificial intelligence. Further, based on the music style 331, an audio track 333 may be generated using artificial intelligence.

In particular, data 305 and 320 are captured for input into the deep/machine learning engine 195, trained to perform audio track synchronization by applying machine learning. The data may be collected through a communication network 150, or directly delivered. For example, data 320 used for determining, in part, game play tempo includes game state data 321 from a game play of a video game by a user corresponding to a video clip; one or more video clips, each of which include a plurality of screen shots 322 and/or video frames from a corresponding game play of a corresponding video game; one or more audio segments 323 may also be isolated from each of the video clips; user biometrics 325, and other information (e.g., metadata, user data, etc.). In addition, data 305 used for generating, in part, an audio track to accompany one or more video clips (e.g., highlight reel) includes a base soundtrack 306 from a corresponding video clip; and user selected audio tracks 307. As previously described, user selected audio tracks 307 may include one or more music (e.g., songs) available through web music platforms (e.g., a playlist), or independently generated music, or user generated music, etc.

Specifically, game state data defines the state of the game play of an executing video game for a player at a particular point in time. Game state data allows for the generation of the gaming environment at the corresponding point in the game play. For example, game state data may include states of devices used for rendering the game play (e.g., states of the CPU, GPU, memory, register values, etc.), identification of the executable code to execute the video game at that point, game characters, game objects, object and/or game attributes, graphic overlays, and other information. User saved data includes information that personalizes the video game for the corresponding player. For example, user saved data may include character information and/or attributes that are personalized to a player (e.g., location, shape, look, clothing, weaponry, assets, etc.) in order to generate a character and character state that is unique to the player for the point in the game play, game attributes for the player (e.g., game difficulty selected, player customized game settings, game level, character attributes, character location, number of lives, trophies, achievements, rewards, etc.), user profile data, and other information. Metadata is configured to provide relational information and/or context for other information, such as the game state data and the user saved data. For example, metadata May include information describing the gaming context of a particular point in the game play of a player, such as where in the game the player is, type of game, mood of the game, rating of game (e.g., maturity level), the number of other players there are in the gaming environment, game dimension displayed, the time of the collection of information, the types of information collected, region or location of the internet connection, which players are playing a particular gaming session, descriptive information, game title, game title version, franchise, format of game title distribution, network connectivity, downloadable content accessed, links, language, system requirements, hardware, credits, achievements, awards, trophies, and other information.

Data 320 and/or data 305 may be provided to the feature extractor 310 to identify salient and relevant information used for synchronizing an audio track to game play tempo of a video clip, or generating an audio track using artificial intelligence, etc. For example, the feature extractor may be configured to define features useful in identifying game play tempo, game context of a game play, in-game related actions, timing of a base soundtrack in a video clip, key events used for determining game context, music style corresponding to the game context, and for generating an audio track based on the music style. Further, the extracted features may be classified and/or labeled by the classification/label engine 315 prior to submission to the AI model 170 as input 316. In some implementations, data 320 and 305 may be provided directly to the machine learning engine 195, such as when feature extraction and/or classification are performed internally by the AI model, or for use by the AI model 170 (e.g., supply the captured audio track for synchronization).

As shown, the deep/machine learning engine 195 is configured for implementation of AI model 170 based on an input set of data (e.g., extracted features that may be further classified and/or labeled. In one embodiment, the AI model 170 is a machine learning model configured to apply machine learning to synchronize an audio track to a game play tempo. In another embodiment, the AI learning model is a deep learning model configured to apply deep learning to perform the same operations, wherein machine learning is a sub-class of artificial intelligence, and deep learning is a sub-class of machine learning. As such, artificial intelligence is used for synchronizing an audio track to a game play tempo of a game play of a video game.

Purely for illustration, the deep/machine learning engine 195 may be configured as a neural network used to train and/or implement the AI model 170, in accordance with one embodiment of the disclosure. Generally, the neural network represents a network of interconnected nodes, such as an artificial neural network, and is configured for responding to input (e.g., extracted features) and generating an output related generally to synchronizing an audio track to a game play shown in a video clip, and/or synchronizing an audio track, that may include one or more audio segments, to one or more game plays of one or more video games shown in a highlight reel.

In one implementation, the AI neural network includes a hierarchy of nodes. For example, there may be an input layer of nodes, an output layer of nodes, and intermediate or hidden layers of nodes. Input nodes are interconnected to hidden nodes in the hidden layers, and hidden nodes are interconnected to output nodes. Each node learns some information from data. Knowledge can be exchanged between the nodes through the interconnections. Interconnections between nodes may have numerical weights that may be used link multiple nodes together between an input and output, such as when defining rules of the AI model 170. Input to the neural network activates a set of nodes. In turn, this set of nodes activates other nodes, thereby propagating knowledge about the input. This activation process is repeated across other nodes until an output is provided

For example, the AI model 170 is configured to apply rules defining relationships between features and outputs, wherein features may be defined within one or more nodes that are located at one or more hierarchical levels of the AI model 170. The rules link features (as defined by the nodes) between the layers of the hierarchy, such that a given input set of data leads to a particular output (e.g., a key event during game play of a video game) of the AI model 170. For example, a rule may link (e.g., using relationship parameters including weights) one or more features or nodes throughout the AI model 170 (e.g., in the hierarchical levels) between an input and an output, such that one or more features make a rule that is learned through training of the AI model 170. That is, each feature may be linked with one or more features at other layers, wherein one or more relationship parameters (e.g., weights) define interconnections between features at other layers of the AI model 170. As such, each rule or set of rules corresponds to a classified output.

The AI model 170 is executed for a given set of extracted features that are classified and provided as input 316. In particular, data relevant for providing an audio track synchronized to game play tempo of a video clip, or for generating an audio track using artificial intelligence is generated according to the rules of the AI model 170. As such, the AI model may be executed to perform one or more interim processes, each of which is configured to identify/determine/generate/classify data, including one or more of data 340 and data 330 used for determining game play tempo 343 and/or generating an audio track.

For example, the AI model 170 is configured at least to identify and/or classify and/or generate one or more of the following data 340 used for synchronizing an audio track to game play shown in a video clip. For example, the AI model 170 may be configured to determine in-game related actions 341, which may be user based or may be character/object based, wherein the character and/or object are interacting with a gaming environment of the video game. As previously described, user based actions may include actions performed by the user to control the game play, including interactions with a controller, or movements by the user, to generate controller inputs. The rate of actions may be determined, such as a rate or change of rate of user actions (i.e., rate of providing controller inputs). Other user based actions may include capturing biometric data to determine emotions of the user, such as when the user is agitated, or excited, or peaceful. In addition, the AI model may be configured to determining audio or musical timing 342 of a base soundtrack provided with the game play and generated by the corresponding video game. The timing of the base soundtrack may provide a starting point for audio track synchronization.

More particularly, the AI model 170 is configured for determining a game play tempo 343 based on the in-game related actions 341 and/or the timing 342 of the base soundtrack. For example, the game play tempo is a reflection of the performance of in-game related actions, such as a rate at which the actions are performed. The game play tempo may vary with performance of the in-game related actions. As an illustration, user based actions may include a rate of activating controller inputs, that may be used to control movement and/or actions of a character within the game play. User based actions need not always control the game play, as the user may have an internal rhythm when playing any video game, and may or may not be related to the game play. As the activation rate of controller inputs varies during the game play, the game play tempo may also vary. In that manner, the game play tempo may increase as the user is approaching and then engaging with a boss, but then decrease to a more pacified state after disengaging with the boss. That is, the game play tempo may vary throughout a video clip. In addition, character or object based actions may include motions or sounds performed by a character or object. The motion of a character or object may also occur at a corresponding rate, which may vary throughout the video clip. As an illustration, a particular motion of a character may be repeatedly used when battling a boss. The corresponding rate of the use of that motion determines the corresponding rate of the in-game related action, which may be further used to determine the game play tempo.

As previously described, game play tempo may also reflect an emotion of the user, or an intensity of performing the in-game related actions. For instance, magnitude or forcefulness when activating a controller input may indicate a relative intensity or emotion of the user, such as high intensity or emotion when the magnitude is high, or low intensity or emotion when the magnitude is low. Also, timing of the activation of controller inputs may also indicate user intensity or emotion, or changes in user intensity or emotion. For example, a high rate of activating controller inputs may indicate high intensity or emotion, and a low rate of activation may indicate low or normal intensity or emotion. Also, a change in the rate of activating controller inputs may indicate a shift between intensities or emotions.

Furthermore, the AI model 170 is configured for synchronizing an audio track to the game play tempo 343. As previously described, the audio track may be of any type, including the base soundtrack that is generated for the game play by the corresponding video game (e.g., shown in the video clip), user created audio (e.g., sounds, music, etc.), and user selected audio (e.g., music on a playlist of one or more songs accessed through a web music platform), etc. Once the audio track is selected and/or determined, the audio track is manipulated to be in synchronization and/or alignment with the game play tempo. For example, the beat of audio (e.g., sounds or notes, bars, measures, etc.) within an audio track can be stretched or shrunken in time (e.g., increasing or decreasing a beats per period of time) to occur with AI determined in-game related actions, wherein the in-game related actions are used for determining a corresponding game play tempo. As an illustration, the audio track may be modified using artificial intelligence such that the beats per minute of the audio track is synchronized and/or aligned with the rate of the controller inputs entered by the user. More particularly, as the game play tempo varies, the manipulation of the audio track also reacts to the variation in the game play tempo. In that manner, the audio track continually is synchronized with the in-game related actions corresponding with the game play tempo.

Also, the AI model 170 is configured at least to identify and/or classify and/or generate one or more of the following data 330 used for generating an audio track that can then by synchronized to game play shown in a video clip (e.g., game play tempo), as previously discussed. For example, the AI model 170 may be configured to determine key events 332. As previously described, key events include interactions with a gaming environment that are significant to the game play, and may or may not progress the game play. Other key events may be important to the experience of the user, and are personal or specific to the game play of the user, such as performing or finishing one or more side quests for a user that enjoys side quests. The interactions may be centered around a character that is controlled by the user. For purposes of illustration, key events include, in part, areas or regions visited within the gaming environment, passing a level, quests started, quests completed, achievements, tasks started and/or completed, assets earned (e.g., weapons, treasure, etc.), battling a boss, beating a boss, passing a level, interactions with NPCs, etc. As such, the key events may be used when performing artificial intelligence to determine a game context 334 of the game play.

The game context 334 and/or key events 332 can then be analyzed by the AI model 170 to determine a musical style 331. For instance, one or more musical styles could be defined for one or more game contexts of video games in general. Musical styles could be taken from other industries, such as the movie industry where certain styles of music are used to accompany particular themes portrayed in movies. For example, music of a first musical style (loud, percussive, and high beats per minute) would accompany a scene that is reflective of high intensity, while music of a second musical style would accompany a highly emotional scene, and a third musical style would accompany a peaceful scene. The musical style 331 that is determined can be used by the AI model 170 to generate an audio track 333 to accompany the game play shown in the video clip. As previously described, the audio track 333, if selected to accompany the video clip, can be synchronized with the game play of the video clip.

As such, the resulting output 350 generated according to the rules of the AI model 170 may include a video clip 351 overlaid with an audio track that is synchronized to the game play tempo of the game play shown in the video clip. In one embodiment, the video clip may be a recording, and when the user replays that video clip, instead of playing a base soundtrack that originally accompanied the corresponding game play, an audio track that is synchronized with the corresponding game play tempo now accompanies the game play shown in the video clip. As previously described, the audio track may be of any type, such as self-created music, or a playlist, or even the base soundtrack, etc.

In another embodiment, a highlight reel 352 is generated from one or more video games played by a user over a period of time. Again, an audio track of any type may be selected and synchronized with the game play tempo of the one or more game plays in the highlight reel. In one specific implementation, the AI model 170 is used to generate an audio track based off the music from the video games. For example, captured audio clips from the game plays by the user may be selected and composited to generate the audio track. In another case, the captured audio clips are used to generate a new audio track solely for the highlight reel. As such, the audio track that accompanies (e.g., overlaid) the highlight reel is further manipulated (e.g., stretched or shrunken in time, etc.) to be in synchronization with the game play tempo of each video clip shown in the highlight reel. In that manner, the video clip and/or highlight reel including one or more video clips is overlaid with the new and/or modified audio track, in order to give the user a more personal, and/or theatrical or impactful experience when viewing the video clip and/or highlight reel.

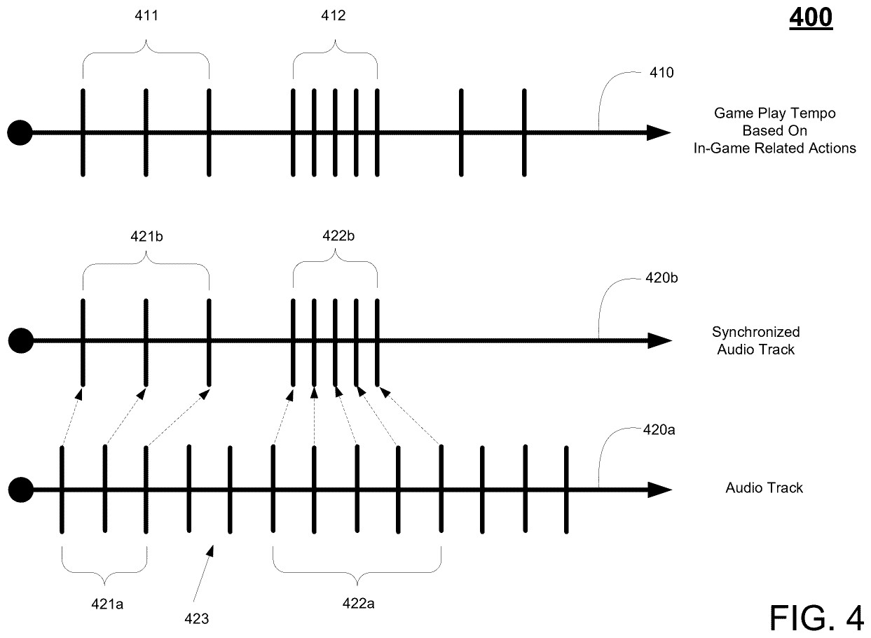

FIG. 4 is a diagram 400 illustrating the synchronization of an audio track with a game play tempo of a game play of a video game shown in a video clip, in accordance with one embodiment of the present disclosure. As shown, three timelines are shown corresponding with a game play tempo, an unmodified audio track, and a modified audio track that is synchronized with the game play tempo.

In particular, timeline 410 shows a game play tempo for a game play presented in a video clip, or highlight reel. As previously described, the game play tempo may vary according to variations in the rate of corresponding in-game related actions. For example, portion 411 may show a relatively slow game play tempo that corresponds with a slow rate of occurrences of in-game related actions. As an illustration, the corresponding game context may be relatively calm. In contrast, portion 412 may show a relatively high game play tempo that corresponds with a high rate of occurrences of in-game related actions. As an illustration, the corresponding game context may be more intense, such as when battling a boss.

Timeline 420a shows an audio track that is unmodified. As previously described, the audio track may be of any type, such as user created audio, audio from a playlist of one or more songs accessed through a web music platform, the base soundtrack, etc. As shown, the audio track includes a constant number of beats per unit of time (e.g., minute), wherein the beats may be notes, bars, measures, etc.

Timeline 420b shows manipulation of the audio track, shown in timeline 420a, to be in synchronization with the game play tempo shown in timeline 410. As previously described, one or more portions of the audio track can be stretched or shrunken in time (e.g., modifying the beats per minute) to synchronize with each of the variations of the game play tempo. In one embodiment, manipulation of the audio track is accomplished without compromising the pitch. In another embodiment, a pitch in the audio track may vary in response to stretching or shrinking of the audio track. For example, a portion of the audio track can be stretched or shrunken to synchronize with occurrences of one or more the in-game related actions. That is, the stretching or shrinking is performed to change a rate of beats or sounds in the audio track. The rate may be related to notes, or bars, or measures, or other sounds performed per minute. As such, stretching and/or shrinking may refer to an increase or decrease in the beats per minute of the audio track to synchronize with occurrences and/or rate of occurrences of one or more the in-game related actions. In that manner, the modified audio track is consistent with and follows the game play tempo of the game play shown in the corresponding video clip.

As shown, segment 421a of the unmodified audio track shown in timeline 420a is manipulated to correspond with portion 411 of the game play tempo that is relatively slow (e.g., corresponding with a slow rate of performing in-game related actions). Because the rate of beats for the unmodified audio track, shown in timeline 420a, may be faster than the game play tempo of portion 411, the segment 421a is stretched. For example, the modified rate of beats in segment 421b (e.g., stretched in time) of timeline 420b is synchronized with the game play tempo shown in portion 411 of timeline 410.

The same audio track is manipulated to be in synchronization with the game play tempo shown in portion 412 of timeline 410. In particular, segment 422a of the unmodified audio track shown in timeline 420a is manipulated to correspond with portion 412 of the game play tempo that is relatively high (e.g., corresponding with a high rate of occurrences of in-game related actions). Because the rate of beats for the unmodified audio track, shown in timeline 420a, may be much slower than the game play tempo of portion 412, the segment 422a is shrunken. For example, the modified rate of beats (e.g., shrunken in time) in segment 422b of timeline 420b is synchronized with the game play tempo shown in portion 412 of timeline 410.

For purposes of clarity, one or more portions (e.g., portion 423) of the unmodified audio track shown in timeline 420a may be played between defined game play tempos corresponding with occurrences of in-game related actions. For example, these portions may broadcast the original audio track that is unmodified, or play one of the segments that may have been modified.

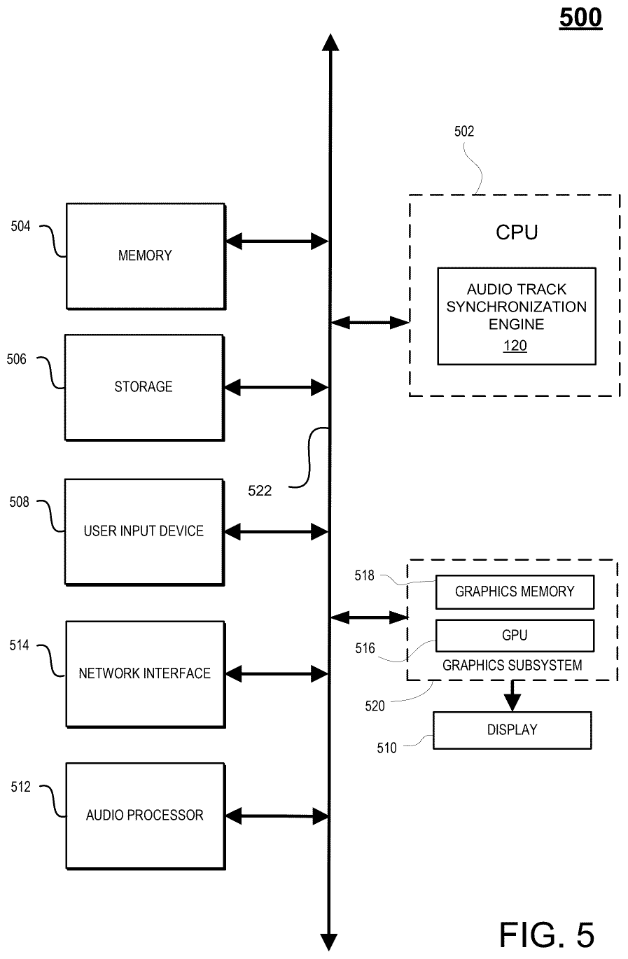

FIG. 5 illustrates components of an example device 500 that can be used to perform aspects of the various embodiments of the present disclosure. This block diagram illustrates a device 500 that can incorporate or can be a personal computer, video game console, handheld video game console, personal digital assistant, a server or other digital device, and includes a central processing unit (CPU) 502 for running software applications and optionally an operating system. CPU 502 may be comprised of one or more homogeneous or heterogenous processing cores. Further embodiments can be implemented using one or more CPUs with microprocessor architectures specifically adapted for highly parallel and computationally intensive applications.

In particular, CPU 502 may be configured to implement an audio track synchronization engine 120 that is configured to synchronize an audio track with a game play tempo corresponding with a video clip of a game play of a video game that is live or recorded, using artificial intelligence. In particular, artificial intelligence can be used to identify in-game related actions corresponding with the game play in the video clip, and determine the game play tempo based on the in-game related actions. Artificial intelligence is used to manipulate the audio track to be in synchronization and/or alignment with the game play tempo. The modified audio track is overlaid the video clip. In that manner, a customized audio track is generated that is more personal or more theatrical or more impactful when viewing the video clip.

Memory 504 stores applications and data for use by the CPU 502. Storage 506 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 508 communicate user inputs from one or more users to device 500, examples of which may include keyboards, mice, joysticks, touch pads, touch screens, still or video recorders/cameras, tracking devices for recognizing gestures, and/or microphones. Network interface 514 allows device 500 to communicate with other computer systems via an electronic communications network, and may include wired or wireless communication over local area networks and wide area networks such as the internet. An audio processor 512 is adapted to generate analog or digital audio output from instructions and/or data provided by the CPU 502, memory 504, and/or storage 506. The components of device 500 are connected via one or more data buses 522.

A graphics subsystem 520 is further connected with data bus 522 and the components of the device 500. The graphics subsystem 520 includes a graphics processing unit (GPU) 516 and graphics memory 518. Graphics memory 518 includes a display memory (e.g., a frame buffer) used for storing pixel data for each pixel of an output image. Pixel data can be provided to graphics memory 518 directly from the CPU 502. Alternatively, CPU 502 provides the GPU 516 with data and/or instructions defining the desired output images, from which the GPU 516 generates the pixel data of one or more output images. The data and/or instructions defining the desired output images can be stored in memory 504 and/or graphics memory 518. In an embodiment, the GPU 516 includes 3D rendering capabilities for generating pixel data for output images from instructions and data defining the geometry, lighting, shading, texturing, motion, and/or camera parameters for a scene. The GPU 516 can further include one or more programmable execution units capable of executing shader programs. In one embodiment, GPU 516 may be implemented within an AI engine (e.g., machine learning engine 195) to provide additional processing power, such as for the AI, machine learning functionality, or deep learning functionality, etc.

The graphics subsystem 520 periodically outputs pixel data for an image from graphics memory 518 to be displayed on display device 510. Display device 510 can be any device capable of displaying visual information in response to a signal from the device 500.

In other embodiments, the graphics subsystem 520 includes multiple GPU devices, which are combined to perform graphics processing for a single application that is executing on a CPU. For example, the multiple GPUs can perform alternate forms of frame rendering, including different GPUs rendering different frames and at different times, different GPUs performing different shader operations, having a master GPU perform main rendering and compositing of outputs from slave GPUs performing selected shader functions (e.g., smoke, river, etc.), different GPUs rendering different objects or parts of scene, etc. In the above embodiments and implementations, these operations could be performed in the same frame period (simultaneously in parallel), or in different frame periods (sequentially in parallel).

Accordingly, in various embodiments the present disclosure describes systems and methods configured for synchronizing an audio track with a game play tempo corresponding with a video clip of a game play of a video game that is live or recorded, using artificial intelligence. The video clip may be overlaid with the modified audio track for viewing. In that manner, the video clip is overlaid with the new and/or modified audio track, in order to give the user a more personal, and/or theatrical or impactful experience when viewing the video clip.

It should be noted, that access services, such as providing access to games of the current embodiments, delivered over a wide geographical area often use cloud computing. Cloud computing is a style of computing in which dynamically scalable and often virtualized resources are provided as a service over the Internet. For example, cloud computing services often provide common applications (e.g., video games) online that are accessed from a web browser, while the software and data are stored on the servers in the cloud.

A game server may be used to perform operations for video game players playing video games over the internet, in some embodiments. In a multiplayer gaming session, a dedicated server application collects data from players and distributes it to other players. The video game may be executed by a distributed game engine including a plurality of processing entities (PEs) acting as nodes, such that each PE executes a functional segment of a given game engine that the video game runs on. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. The PEs may be virtualized by a hypervisor of a particular server, or the PEs may reside on different server units of a data center. Respective processing entities for performing the operations may be a server unit, a virtual machine, or a container, GPU, CPU, depending on the needs of each game engine segment. By distributing the game engine, the game engine is provided with elastic computing properties that are not bound by the capabilities of a physical server unit. Instead, the game engine, when needed, is provisioned with more or fewer compute nodes to meet the demands of the video game.

Users access the remote services with client devices (e.g., PC, mobile phone, etc.), which include at least a CPU, a display and I/O, and are capable of communicating with the game server. It should be appreciated that a given video game may be developed for a specific platform and an associated controller device. However, when such a game is made available via a game cloud system, the user may be accessing the video game with a different controller device, such as when a user accesses a game designed for a gaming console from a personal computer utilizing a keyboard and mouse. In such a scenario, an input parameter configuration defines a mapping from inputs which can be generated by the user's available controller device to inputs which are acceptable for the execution of the video game.

In another example, a user may access the cloud gaming system via a tablet computing device, a touchscreen smartphone, or other touchscreen driven device, where the client device and the controller device are integrated together, with inputs being provided by way of detected touchscreen inputs/gestures. For such a device, the input parameter configuration may define particular touchscreen inputs corresponding to game inputs for the video game (e.g., buttons, directional pad, gestures or swipes, touch motions, etc.).

In some embodiments, the client device serves as a connection point for a controller device. That is, the controller device communicates via a wireless or wired connection with the client device to transmit inputs from the controller device to the client device. The client device may in turn process these inputs and then transmit input data to the cloud game server via a network. For example, these inputs might include captured video or audio from the game environment that may be processed by the client device before sending to the cloud game server. Additionally, inputs from motion detection hardware of the controller might be processed by the client device in conjunction with captured video to detect the position and motion of the controller before sending to the cloud gaming server.

In other embodiments, the controller can itself be a networked device, with the ability to communicate inputs directly via the network to the cloud game server, without being required to communicate such inputs through the client device first, such that input latency can be reduced. For example, inputs whose detection does not depend on any additional hardware or processing apart from the controller itself can be sent directly from the controller to the cloud game server. Such inputs may include button inputs, joystick inputs, embedded motion detection inputs (e.g., accelerometer, magnetometer, gyroscope), etc.

Access to the cloud gaming network by the client device may be achieved through a network implementing one or more communication technologies. In some embodiments, the network may include 5th Generation (5G) wireless network technology including cellular networks serving small geographical cells. Analog signals representing sounds and images are digitized in the client device and transmitted as a stream of bits. 5G wireless devices in a cell communicate by radio waves with a local antenna array and low power automated transceiver. The local antennas are connected with a telephone network and the Internet by high bandwidth optical fiber or wireless backhaul connection. A mobile device crossing between cells is automatically transferred to the new cell. 5G networks are just one communication network, and embodiments of the disclosure may utilize earlier generation communication networks, as well as later generation wired or wireless technologies that come after 5G.

In one embodiment, the various technical examples can be implemented using a virtual environment via a head-mounted display (HMD), which may also be referred to as a virtual reality (VR) headset. As used herein, the term generally refers to user interaction with a virtual space/environment that involves viewing the virtual space through an HMD in a manner that is responsive in real-time to the movements of the HMD (as controlled by the user) to provide the sensation to the user of being in the virtual space or metaverse. An HMD can be worn in a manner similar to glasses, goggles, or a helmet, and is configured to display a video game or other metaverse content to the user. The HMD can provide a very immersive experience in a virtual environment with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures (e.g., commands, communications, pointing and walking toward a particular content item in the scene, etc.). In one embodiment, the gestures can be tracked and processed by the system to generate a prediction of interaction with the particular content item in the game scene. In some embodiments, machine learning may be used to facilitate or assist in the prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network, such as internet, cellular, etc. In one embodiment, the cloud computing and gaming system maintains and executes the video game being played by the user. In some embodiments, the cloud computing and gaming system is configured to receive inputs from the HMD and/or interfacing objects over the network. The cloud computing and gaming system is configured to process the inputs to affect the game state of the executing video game. The output from the executing video game, such as video data, audio data, and haptic feedback data, is transmitted to the HMD and the interface objects.

Additionally, though implementations in the present disclosure may be described with reference to an HMD, it will be appreciated that in other implementations, non-HMDs may be substituted, such as, portable device screens (e.g., tablet, smartphone, laptop, etc.) or any other type of display that can be configured to render video and/or provide for display of an interactive scene or virtual environment. It should be understood that the various embodiments defined herein may be combined or assembled into specific implementations using the various features disclosed herein. Thus, the examples provided are just some possible examples, without limitation to the various implementations that are possible by combining the various elements to define many more implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

With the above embodiments in mind, it should be understood that embodiments of the present disclosure can employ various computer-implemented operations involving data stored in computer systems. These operations are those requiring physical manipulation of physical quantities. Any of the operations described herein in embodiments of the present disclosure are useful machine operations. Embodiments of the disclosure also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server, or by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation may be produced by an emulator that emulates a processing system.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. A method, comprising:
capturing information related to a game play of a video game presented in a video clip;
executing an artificial intelligence (AI) model using the information to determine a game play tempo of in-game related actions for the game play of the video game;
executing the AI model to synchronize an audio track to the game play tempo; and
overlaying the audio track that is synchronized to the video clip for presentation.

2. The method of claim 1, wherein the capturing information includes:
accessing game state data for the game play of the video game,
wherein the AI model analyzes the game state data to determine the game play tempo.

3. The method of claim 1, wherein the capturing information includes:
capturing a plurality of image frames of the video clip,
wherein the AI model analyzes the plurality of image frames to determine the game play tempo.

4. The method of claim 1, wherein the capturing information includes:
capturing biometric information related to a user controlling the game play of the video game,
wherein the AI model analyzes the biometric information to determine the game play tempo.

5. The method of claim 1, wherein the executing the AI model to synchronize the audio track includes:
manipulating a beat of the audio track to synchronize with one or more the in-game related actions.

6. The method of claim 5,
wherein the in-game related actions includes user based actions, or character based actions of a character controlled by the user in the game play of the video game.

7. The method of claim 1, wherein the executing the AI model to synchronize the audio track includes one or more of the following:
manipulating a volume of the audio track; or
stretching the audio track; or
stretching the audio track while keeping a pitch of the audio track; or
shrinking the audio track; or
shrinking the audio track keeping the pitch of the audio track.

8. The method of claim 1, further comprising:
accessing the audio track, wherein the audio track includes at least one of the following:
an audio segment broadcast during the video clip, wherein the audio segment is taken from a base sound track of the video game; or
original music; or
a play list of one or more songs selected by the user; or
a play list of one or more songs of a genre selected by the user.

9. The method of claim 1, further comprising:
executing the AI model to identify one or more key events in the game play of the video game presented in the video clip;
executing the AI model to determine a context of the game play of the video game presented in the video clip;
executing the AI model to determine a style of music corresponding with the one or more key events and the context; and
executing the AI model to generate the audio track based on the style of music.

10. The method of claim 1, further comprising:
accessing a highlight reel including a plurality of video clips of a plurality of game plays of a plurality of video games;
accessing a plurality of audio segments broadcast during the plurality of video clips, wherein the plurality of audio clips is taken from a plurality of base sound tracks of the plurality of video games; and
executing the AI model to generate an audio track based on the plurality of audio segments.

11. The method of claim 1, further comprising:
extracting a plurality of features from the information,
wherein the AI model analyzes the plurality of features to determine the game play tempo.

12. The method of claim 11, wherein the plurality of features includes at least one of the following:
rate of user input configured for controlling the game play of the video game; or
one or more controller inputs of a controller input sequence; or
magnitude and timing for each of the one or more controller inputs.

13. A computer system comprising:
a processor; and
memory coupled to the processor and having stored therein instructions that, if executed by the computer system, cause the computer system to execute a method comprising:
capturing information related to a game play of a video game presented in a video clip;
executing an artificial intelligence (AI) model using the information to determine a game play tempo of in-game related actions for the game play of the video game;
executing the AI model to synchronize an audio track to the game play tempo; and
overlaying the audio track that is synchronized to the video clip for presentation.

14. The computer system of claim 13, wherein in the method the capturing information includes:
accessing game state data for the game play of the video game,
wherein the AI model analyzes the game state data to determine the game play tempo.

15. The computer system of claim 13, wherein in the method the capturing information includes:
capturing a plurality of image frames of the video clip,
wherein the AI model analyzes the plurality of image frames to determine the game play tempo.

16. The computer system of claim 13, wherein in the method the executing the AI model to synchronize the audio track includes:
manipulating a beat of the audio track to synchronize with one or more the in-game related actions,
wherein the in-game related actions includes user based actions, or character based actions of a character controlled by the user in the game play of the video game.

17. The computer system of claim 13, wherein in the method the executing the AI model to synchronize the audio track includes one or more of the following:
manipulating a volume of the audio track; or
stretching the audio track; or
stretching the audio track while keeping a pitch of the audio track; or
shrinking the audio track; or
shrinking the audio track keeping the pitch of the audio track.

18. A non-transitory computer-readable medium storing a computer program for performing a method, the computer-readable medium comprising:
program instructions for capturing information related to a game play of a video game presented in a video clip;
program instructions for executing an artificial intelligence (AI) model using the information to determine a game play tempo of in-game related actions for the game play of the video game;
program instructions for executing the AI model to synchronize an audio track to the game play tempo; and
program instructions for overlaying the audio track that is synchronized to the video clip for presentation.

19. The non-transitory computer-readable medium of claim 18, wherein the program instructions for capturing information includes:
program instructions for accessing game state data for the game play of the video game,
wherein the AI model analyzes the game state data to determine the game play tempo.

20. The non-transitory computer-readable medium of claim 18, wherein the program instructions for executing the AI model to synchronize the audio track includes:
program instructions for manipulating a beat of the audio track to synchronize with one or more the in-game related actions,
wherein the in-game related actions includes user based actions, or character based actions of a character controlled by the user in the game play of the video game.
